(19) United States
(12) Patent Application Publication
(10) Pub. No.: US 2009/0157385 A1
(43) Pub. Date: Jun. 18, 2009

(54) Inverse Text Normalization

(75) Inventor: Jilei Tian, Tampere (FI)

Correspondence Address: BANNER & WITCOFF, LTD., 1100 13th STREET, N.W., SUITE 1200, WASHINGTON, DC, 20005-4051, US

(73) Assignee: Nokia Corporation, Espoo (FI)

(21) Appl. No.: 11/956,910

(22) Filed: Dec. 14, 2007

(51) Int. Cl. G06F 17/28

(52) U.S. Cl. 704/9

(57) ABSTRACT

Embodiments are directed to efficient multilingual inverse text normalization (ITN) of text in spoken form to produce normalized text for display. Embodiments are directed to preprocessing the multilingual text into a language-independent representation, tokenizing text in spoken form, segmenting the tokenized text into ITN items by grouping consecutive words using an ITN lexicon, classifying the ITN items into ITN categories by using the ITN lexicon or tagged information from language model, applying one or more ITN rules that are selected based on the ITN categories into which ITN items have been classified to rewrite the ITN items; and post processing the ITN item and outputting inversely normalized text in written form for display. The ITN lexicon may include ITN lexicon entries that are each located within an ITN category in the ITN lexicon.

### FIELD OF THE INVENTION

Embodiments relate generally to speech recognition. More specifically, embodiments relate to inverse text normalization (ITN).

### BACKGROUND OF THE INVENTION

In general terms, text normalization is a process by which text is transformed in some way to make it consistent in a way which it may not have been before it was processed. More specifically, there is text normalization (TN) and inverse text normalization (ITN). Text normalization is often performed before text is processed in some way, such as generating synthesized speech, automated language translation, search, or comparison. On the contrary, speech recognizers are designed to provide text, which corresponds to spoken forms of words, as output. Before displaying the text corresponding to the spoken words, inverse text normalization may be performed to convert the spoken forms of the word into a written or display form. For example, the spoken form of the phrase <two hundred forty three kilometers> may be transformed into display form as <243 km>. Inverse text normalization has not been addressed or studied to the extent that text normalization has.

As speech-to-text dictation systems are being incorporated into text message creation, the inability of speech-recognition systems to produce acceptable textual output substantially diminishes the usefulness of the application, especially in portable devices. For example, a speech recognizer may output the phrase <two hundred forty three kilometers> rather than the sequence of <243 km>. Similar output may be produced by speech-recognition engines for inputs that specify numbers, dates, times, currencies, fractions, abbreviations/acronyms, addresses, phone number, zip code, email or web addresses, metric units, and the like. As a result, users typically have to manually edit the text to put the text into a more acceptable form.

Improved techniques for inverse text normalization that produce more desirable textual output from speech recognition and that are well suited to use in mobile devices, such as mobile phones, would advance the art.

### BRIEF SUMMARY OF THE INVENTION

The following presents a simplified summary in order to provide a basic understanding of some aspects of the invention. The summary is not an extensive overview of the invention. It is neither intended to identify key or critical elements of the invention nor to delineate the scope of the invention. The following summary merely presents some concepts of the invention in a simplified form as a prelude to the more detailed description below.

Embodiments are directed to inverse text normalization (ITN) of text in spoken form from a speech-to-text dictation engine to produce normalized text for display. Embodiments are directed to tokenizing text in spoken form, segmenting the tokenized text into ITN items by grouping consecutive words using an ITN lexicon, classifying the ITN items into ITN categories by using the ITN lexicon, applying one or more ITN rules that are selected based on the ITN categories into which ITN items have been classified to rewrite the ITN items; and post processing the ITN item and outputting inversely normalized text in written form for display. The ITN lexicon may include ITN lexicon entries that are each located within an ITN lexicon category in the ITN lexicon. The ITN lexicon entries each include a spoken word and a corresponding normalized written form of the spoken word. The ITN lexicon categories include a number category.

### BRIEF DESCRIPTION OF THE DRAWINGS

A more complete understanding of the present invention and the advantages thereof may be acquired by referring to the following description in consideration of the accompanying drawings, in which like reference numbers indicate like features, and wherein:

FIG. 1 illustrates an example of a mobile device in which one or more illustrative embodiments of the invention may be implemented.

FIG. 2 is a system diagram showing modules configured to perform inverse text normalization in accordance with one or more embodiments.

FIG. 3 is a flow diagram showing steps for performing inverse text normalization in accordance with one or more embodiments.

FIG. 4 shows an ITN lexicon in accordance with an embodiment.

FIG. 5 shows classification of an ITN item in accordance with an embodiment.

FIG. 6 shows categories of ITN rules (including an example ITN result for each category) in accordance with an embodiment.

FIG. 7 shows a table that may be used for applying ITN rules to an ITN item in accordance with an embodiment.

FIG. 8 shows rules applied to select the cell for a given scanned word in accordance with an embodiment.

FIG. 9 shows post-processing rules in accordance with an embodiment.

FIG. 10 shows an example of ITN processing of a number using a structured table and rewriting rules in accordance with an embodiment.

### DETAILED DESCRIPTION OF THE INVENTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope and spirit of the present invention.

Certain embodiments are directed to efficient inverse text normalization that is configured for use in conjunction with a multilingual embedded speech-to-text dictation system that provides an improved user experience. For example, for a spoken form of: <by the way comma doctor Smith has meeting at ten to ten on seventh October two thousand and seven period best_regards sad_smiley >, the text after inverse text normalization may be: <BTW, Dr. Smith has meeting at 9:50 on 7 Oct. 2007. BR:-(>

Some embodiments are directed to a scheme for efficiently achieving inverse text normalization (ITN) that can be integrated into a multilingual embedded speech-to-text dictation system to significantly improve the user experience. Other embodiments are directed to designing ITN rules for number processing as well as processing other types of text.

By having a general-purpose table design and parsing method, certain embodiments are able to handle multilingual text. This can be a challenging normalization issue. Chinese and English are simple languages in this aspect, but Spanish, French, German, etc., are rather different in number expression. For Spanish, number expression is affected by number (singular or plural), gender (male, female, neuter), with a considerable number of exceptional cases. German sometimes reorders the number expression. For example, <23> may be spoken as <drei und zwanzig>, translated as <three and twenty> in English. French sometimes uses different mixed rule for constructing number expression. For example, <97> may be spoken as <quatre vingt dix sept>, translated as <four times twenty and ten plus seven> in English. These variations may be handled automatically using pre-processing to regularize into general representation that is language-independent. The pre-processing may use rules and/or a lexicon to regularize a language-dependent expression into a language-independent expression. For example, a number expression may be regularly represented as according to a recursive rule: $Pnumber(1)->$D(1) $P(1,0) and $Pnumber(n)->$D(n) $P(n,n−1) $Pnumber(n−1), where D(i) denotes the i-th digit cell and P(i, i−1) stands for a position cell between the i-th and the i−1-th digit in the digit sequence. Then, English <seventeen> may be regularized as <1,P(2,1),7>. German <drei und zwanzig> may be pre-processed as <2,P(2,1),3>, and French <quatre vingt dix sept> may be converted into <9,P(2,1),7>.

Furthermore, a number may be spoken in different ways. For example, <one hundred and six> may be handled as either <106> or <100 and 6> using a language model in a speech recognition engine in accordance with an embodiment. Phone numbers and ordinary numbers may be spoken differently, e.g., <123> may be spoken as <one two three>, <one twenty three> or <one hundred twenty three>. These variations may be handled automatically using a language model with category tagging and conflict checking in accordance with an embodiment. For example, in speech-to-text dictation, a language model may be used to build a recognition network having a vocabulary. The entries in the vocabulary may be defined with category tagging information. Instead of an original number such as <one hundred and six>, an entry may have the following tagged text stream: <one\N hundred\N and\N six\N>. The tagging may be explicitly attached with each entry. In the vocabulary, the word <and> may be split as two words: a general word <and> and a numeral word <and\N>. Thus <one\N hundred\N and\N six\N> would be converted as <106>, and <one\N hundred\N and six\N> would be converted as <100 and 6>. This category tagging may be extended to punctuation, abbreviation, and the like.

Some embodiments are well suited for embedded applications and result in an improved user experience, simple and efficient implementation, a low memory footprint, flexibility and extensibility, and support of multiple languages.

To accommodate multiple languages, numbers may be expressed in a general format that is combination of a single digit D and a position value P, recursively or interleavingly. Digit D may have values of: zero, one, two, three, four, five, six, seven, eight, or nine, and a position value P that may be ones, tens, hundreds, thousands, tens of thousands, etc. In this way, any number may be generally expressed as: number=D P D P . . . .

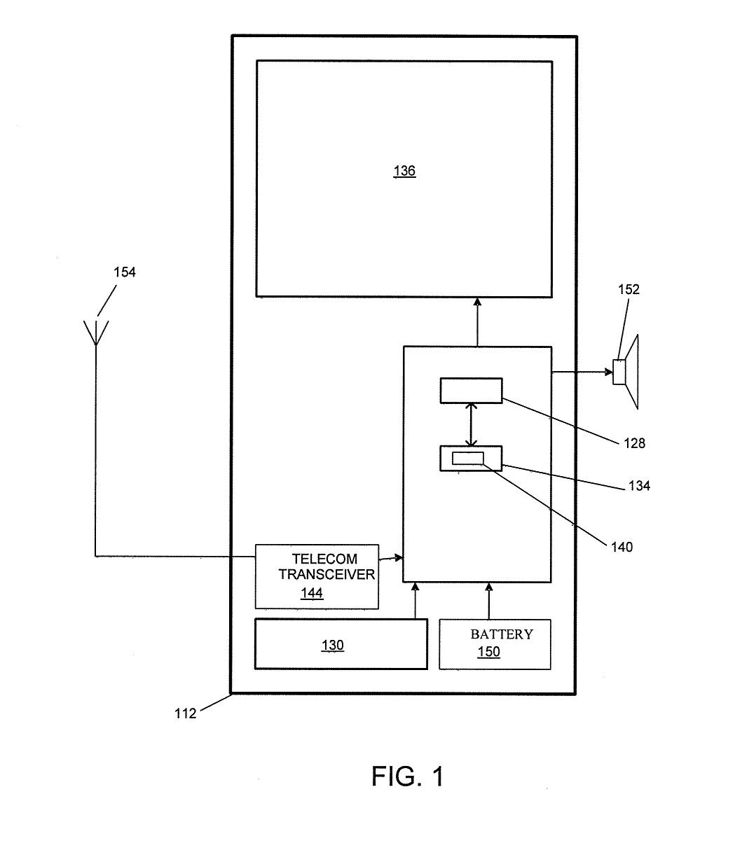

FIG. 1 illustrates an example of a mobile device in which one or more illustrative embodiments of the invention may be implemented. As shown in FIG. 1, mobile device 112 may include processor 128 connected to user interface 130, memory 134 and/or other storage, and display 136, which may be used for displaying information to a mobile-device user. Mobile device 112 may also include battery 150, speaker 152 and one or more antennas 154. User interface 130 may further include a keypad, touch screen, voice interface, one or more arrow keys, joy-stick, data glove, mouse, roller ball, touch screen, or the like.

Computer executable instructions and data used by processor 128 and other components within mobile device 112 may be stored in a computer readable memory 134. The memory may be implemented with any combination of read only memory modules or random access memory modules, optionally including both volatile and nonvolatile memory. Software 140 may be stored within memory 134 and/or storage to provide instructions to processor 128 for enabling mobile device 112 to perform various functions. Alternatively, some or all of mobile device 112 computer executable instructions may be embodied in hardware or firmware (not shown).

Mobile device 112 may be configured to wirelessly exchange messages with other devices via, for example, telecom transceiver 144. The mobile device may also be provided with other types of transceivers, transmitters, and/or receivers.

Inverse text normalization (ITN), in accordance with certain embodiments, allows a mobile device user to speak numbers, times, dates, and other symbolic terms naturally (i.e., in natural language). For example, a natural way to say <$5.20> is <five dollars and twenty cents>. It is not as natural to say <dollar-sign, five point two zero>. ITN in accordance with certain embodiments may also support user-defined terms, such as, text-to-smiley, text-to-icon, and fashionable “aliases” through ITN, e.g., sad_smiley> mapped to <:-(>, <best_regards> mapped to <BR>, and the like.

Particularly in an embedded application, ITN may be integrated into an embedded speech-to-text dictation engine running on mobile devices. The dictation may be developed for short message editing, email, and other document creation on mobile devices.

In certain embodiments, users should be able to define their own normalization lexicon to reflect their special needs, since the general framework may not support a wide variety of real life cases. ITN performs better when more information is available, such as part-of-speech (POS), name entity detection, capitalization assignment, semantic parsing, etc.

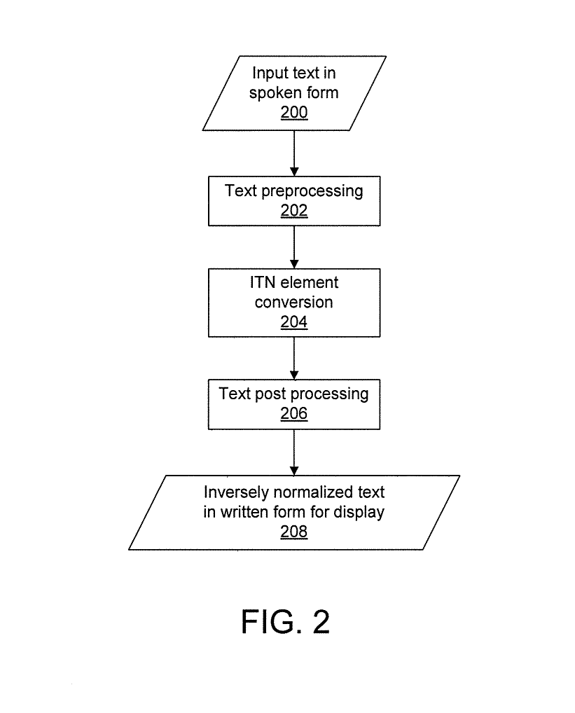

FIG. 2 is a system diagram showing modules configured to perform inverse text normalization in accordance with one or more embodiments. The system shown in FIG. 2 may use the number modeling described above.

Input text in spoken form 200 is input to text preprocessing module 202, which may parse the input text to remove elements that are not useful for performing inverse text normalization. For example, <and\N> may be removed from <one\N hundred\N and\N two\N>); <double six> may be preprocessed as <six six>). Text may also be reordered into canonical form (e.g., converting German number <drei und zwanzig> to be <zwanzig drei>).

Element conversion module 204 converts ITN elements, such as numbers, times, dates, abbreviations, e-mail addresses, and the like, in spoken form to display form using table processing as described in more detail below. ITN element conversion may be performed in accordance with language-independent rules.

Text postprocessing module 206 performs language-specific processing to meet language peculiarities, if any, and/or any exceptional cases to produce inversely normalized text in written form for display 208.

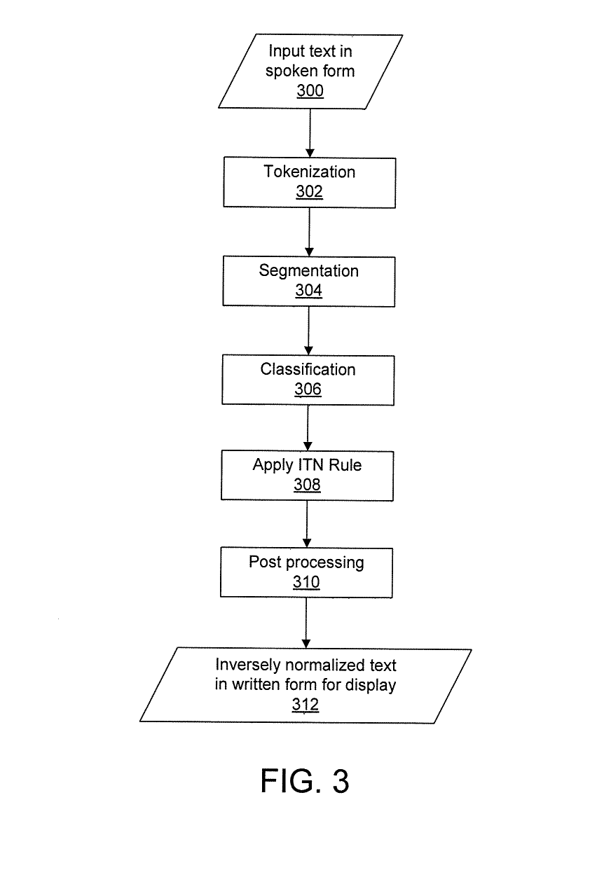

FIG. 3 is a flow diagram showing steps for performing inverse text normalization in accordance with one or more embodiments. The steps shown in FIG. 3 may use the number modeling described above.

Input text in spoken form 300 is input to a tokenization step 302, which may use white space to extract words from the input text. A segmentation step 304 then segments ITN items by grouping consecutive words using an ITN lexicon. A classification step 306 then uses the ITN lexicon to categorize ITN items into categories for selecting one or more appropriate ITN rules. An apply ITN rule step 308 then uses a selected rewrite rule and ITN lexicon to perform ITN on the input text. A post processing step 310 then uses scripting to post process the ITN item and outputs inversely normalized text in written form for display, as shown at 312.

The steps set forth in FIG. 3 can support multilingual languages if the ITN rules are designed to cover multiple languages. The input text stream is split into words, denoted as $W. This may be done using word boundaries (i.e. white space) from the recognized text stream as separators. Then, the identified phrase upon which ITN processing is to be performed is segmented out. This may be triggered by searching through a categorized ITN lexicon. This may also be partially handled by using category tagging extracted from language model entries. This can significantly speed up the parsing processing and improve resolution of ambiguities. In certain embodiments, a rule-based parsing approach may be used for performing classification.

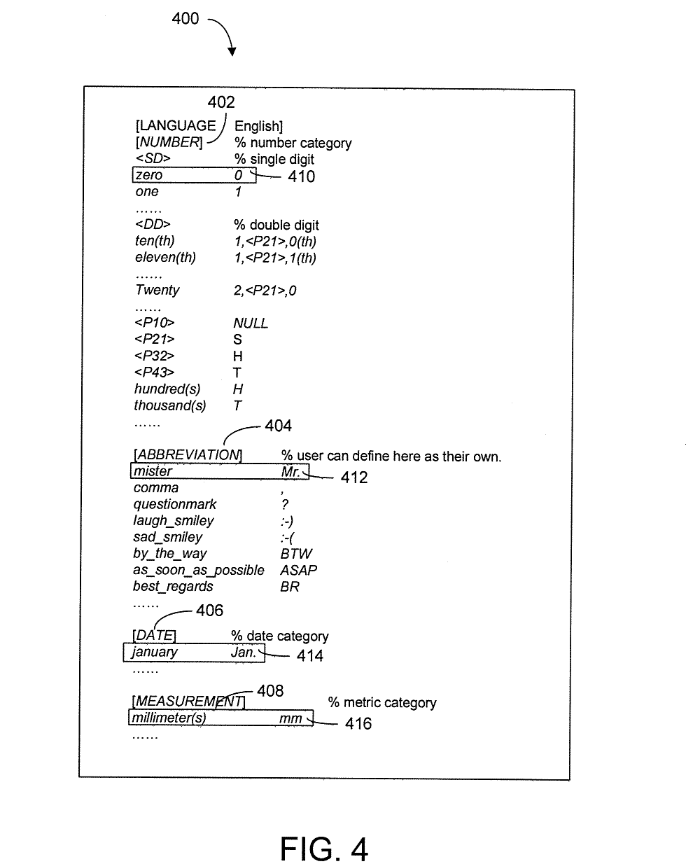

FIG. 4 shows an ITN lexicon 400 in accordance with an embodiment. ITN lexicon entries are each located within a category in the ITN lexicon 400. The following categories are shown in FIG. 4: number 402, abbreviation 404, date 406, and measurement 408. A representative lexicon entry has been labeled in each of the categories as follows: “zero” and “0” 410 in the number category 402; “mister” and “Mr.” 412 in the abbreviation category 404; “January” and “Jan.” 414 in the date category 406; and “millimeter(s)” and “mm” in the measurement category 416.

An entry in the ITN lexicon 400 may include a spoken word (e.g., “three”) and a corresponding normalized written form of the spoken word (e.g., “3”). The spoken word may be denoted as $W, and the corresponding normalized written form of the word may be denoted as $NW=ITN_Lexicon($W). An ITN phrase is a group of words, which may be consecutive and that match a spoken-word portion of an ITN lexicon entry. An ITN phrase is the basic unit of ITN processing, and may be referred to as an ITN item, which may be denoted as $P.

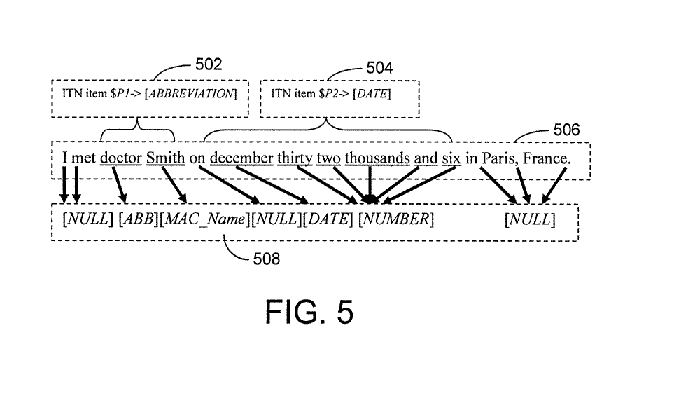

FIG. 5 shows classification of an ITN item in accordance with an embodiment. Given an identified ITN item $P, an ITN lexicon may be used to classify the ITN item into a corresponding category as follows. If ($Wε$P)∩($Wε[classᵢ], and $P matches a classy pattern, then $Pεclassᵢ, where classᵢ may be defined in the ITN lexicon as a priority list in ascending order. For example, the ITN lexicon could assign relative priorities to categories as follows: classᵢε{[NUMBER], [DATE], . . . }. As will be apparent other suitable categories and/or relative priorities between categories may also be used.

In the example shown in FIG. 5, a text stream 506 of spoken words is parsed using an ITN lexicon to segment the text stream 506 into a segmented text stream 508 and to classify ITN phrase items 502 and 504.

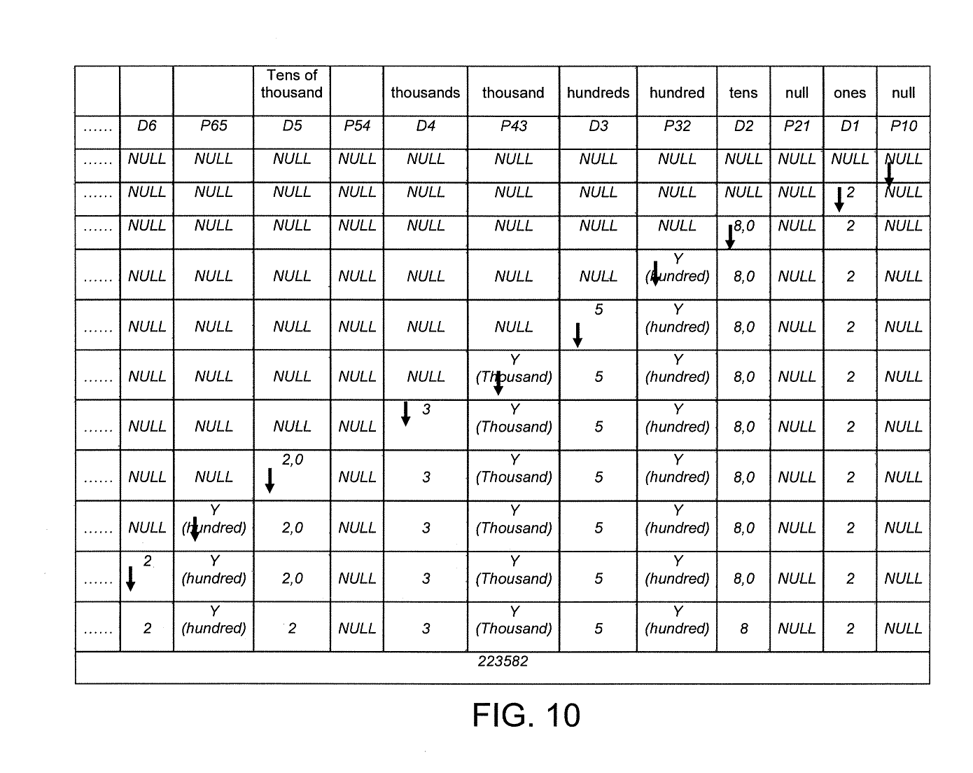

During ITN processing, an applicable rule may be selected based on an ITN phrase item's class. The selected rule may be applied for ITN processing. Then scripting may be used for further processing any cases in which the selected rule does not produce desired results. Reordering and/or calculation are examples of such further processing. The rules may be designed to process numbers in structured data, such as the parsing table shown in FIG. 10. Design of the ITN rules and how the rules may be applied for performing ITN are discussed below. For the example of FIG. 5, each word of the text stream is searched in the ITN lexicon. If it is not found, the word is regarded as a non-ITN word, denoted as <NULL>. If the word is found, then the corresponding class that the found word belongs to in the ITN lexicon is treated as the ITN class for the given word. In certain embodiments, the class tagging may be designed in the language model in the speech-to-text dictation. Suppose <\N> is defined as number tagging, then numbers in the dictation may be denoted as tagged words, for example, <seventeen\N>. An example of such a dictation output is: <I have thirty\N six\N books>. In this way, the class information may be readily identified and/or extracted.

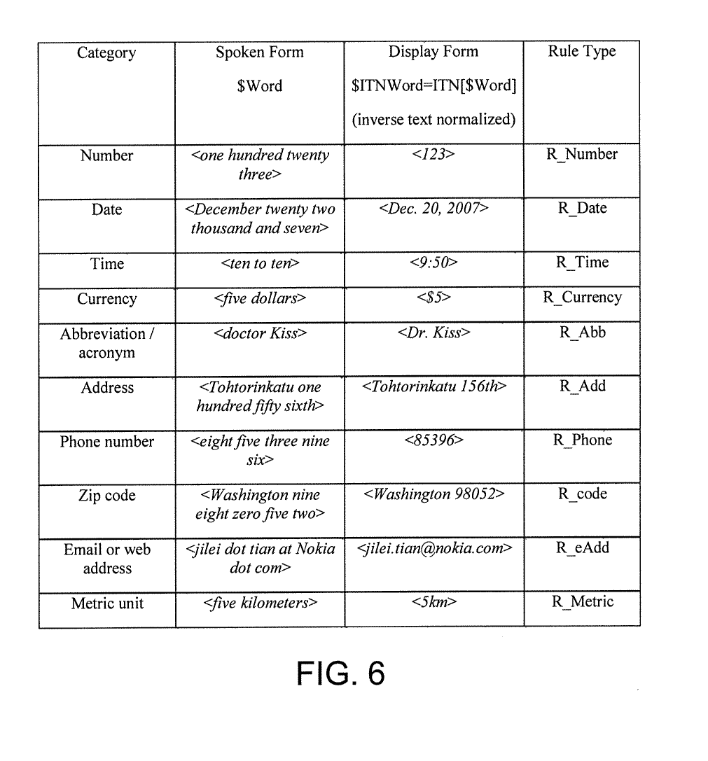

FIG. 6 shows categories of ITN rules (including an example ITN result for each category) in accordance with an embodiment. As shown in FIG. 6, categories may include Number, Date, Time, Currency, Abbreviation/acronym, Address, Phone number, Zip code, Email or web address, and Metric unit. The design of individual rules is discussed below.

Number (R_Number):

A number may be identified by matching a [NUMBER] ITN lexicon entry.

For each $W, such that ($Wε$P)∩($Wε[NUMBER])=TRUE, then $Pε[NUMBER]

The number phrase may be denoted as $Wnumber.

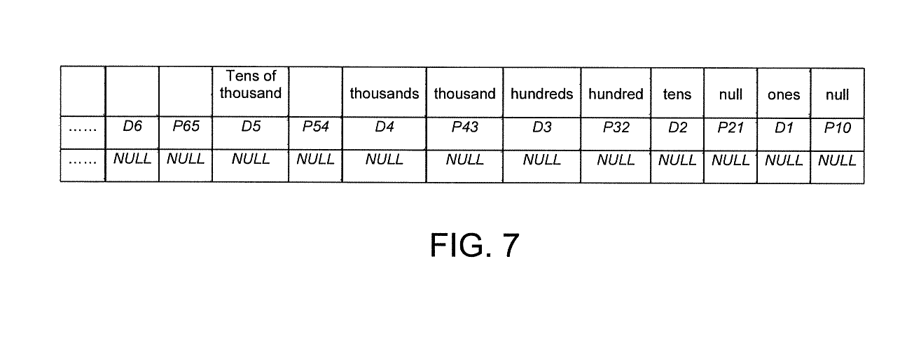

Numbers may include addresses, phone numbers, and the like. In accordance with an embodiment, a number may be processed by using a table-based rewrite rule as shown in FIG. 7. The table in FIG. 7 includes digit cells and position cells marked as D1, D2, . . . , and P10, P21, . . . , respectively. Such a table can accommodate multiple languages since the language specific information is handled in the position and digit values defined in the ITN lexicon. Morphological variation (e.g. inflection, affix, etc.) may be handled with ITN lexicon matching. For example, <hundred> and <hundreds> may be expressed as <hundred(s)>. The number phrase is scanned from right to left, and a moving processing pointer is initially started from the P10 cell, which acts as an anchor marker since its location is fixed.

Initially, the cells of the table may be set as <NULL>. Then, the digit and position cells are filled by parsing an ITN number phrase using an ITN lexicon one by one, from rightmost to leftmost. For example, for the spoken number <two hundred twenty three thousand five hundred eighty two>, processing starts from the rightmost word <two> by scanning one word at each time, from right to left using an ITN lexicon.

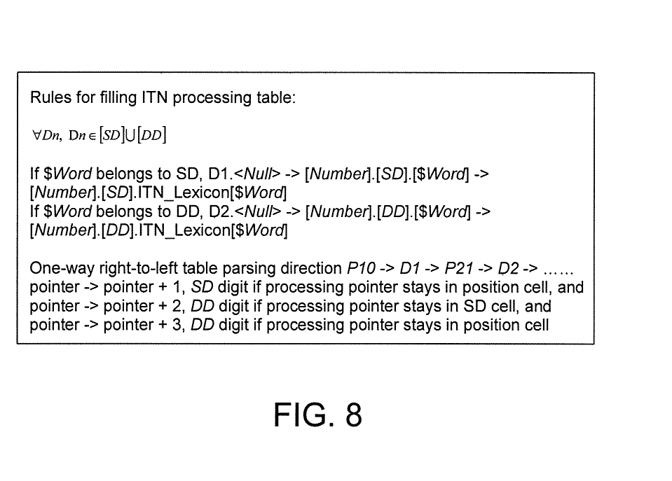

FIG. 8 shows rules applied to select the cell for a given scanned word $Word in accordance with an embodiment. The number processing starts from the rightmost word. If the first word is single digit such as <two> and D1 is <NULL>, then the pointer is moved to D1, and the cell is filled with word value <2>. If the next word is double digit, such as <eighty>, then the pointer is moved two columns to the left into cell D2 from the current single digit cell, D1. If the word is a position, then the pointer is moved left from the current cell to the matched position cell in the table.

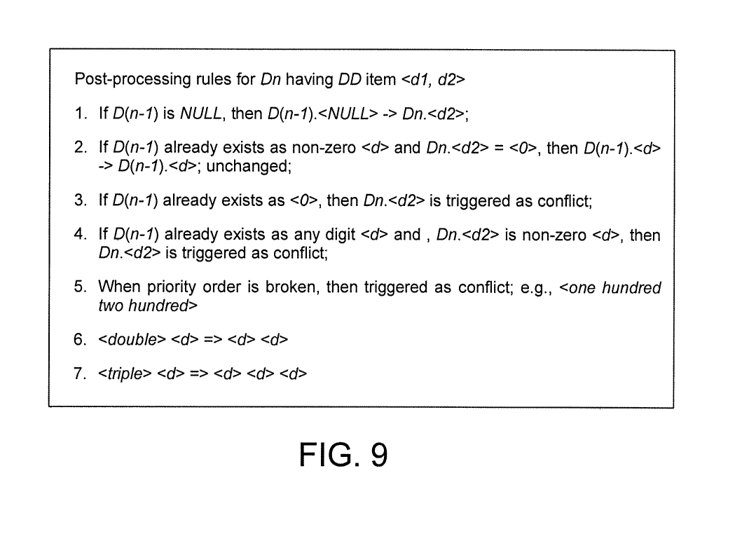

Cells having a double digit (DD) may be post processed using one or more rules so that each digit in the normalized text for display may have a single digit. FIG. 9 shows post-processing rules in accordance with an embodiment. Suppose [SD]={0, 1, 2, 3, 4, 5, 6, 7, 8, 9}, and <d> belongs to [SD], DD=(d1, d2) such as <twenty>=<2,0>, and <eleven>=(1,1). For DD-SD pair, post-processing rules, such as the post-processing rules shown in FIG. 9 may be used. For example, <three> is single digit (SD), then D1.NULL-><three>-><3>, and <twenty> is double digit (DD), then D2.NULL-><twenty>-><2,0>. For the case of <twenty three>, originally we have D(n)=<2,0> and D(n−1)=<3> in the table. As shown in the second rule in FIG. 9, we have D(n)=<2>, and D(n−1)=<3>, meaning D(n−1) has not changed when merging with the second digit <0> of D(n). For the case of <seventeen>, originally we have D(n)=<1,7> and D(n−1)=<NULL> in the table. As shown in the first rule in FIG. 9, we have D(n)=<1>, and D(n−1)=<7>, meaning D(n−1) has assigned the second single digit of D(n). For the case of <twenty zero>, originally we have D(n)=<2,0> and D(n−1)=<0> in the table. As shown in the third rule in FIG. 9, the conflict rule is trigged, then the number is split into two number as <twenty> and <zero> or <20 0>. For the case of <seventeen six>, originally we have D(n)=<1,7> and D(n−1)=<6> in the table. As shown in the fourth rule in FIG. 9, the conflict rule is trigged, then the number is split into two number as <seventeen> and <six> or <17 6>. For the case of <double six>, as shown in the sixth rule in FIG. 9, the expansion rule is trigged, then the number is split into two numbers as <six six> for further processing.

For an example of conflicting cases, consider <five two three>-><5|2|3> and <twenty one fifty six>-><21|56>. The separator marker may be rewritten depending on identified category. [TIME]: <|>-><:>; e.g.: <21|56>-><21:56>; and [NUMBER]: <|>-><NULL> or <.>; <21|56>-><2156> or <21.56> if it is decimal using “point” or “dot” as key words.

FIG. 10 shows an example of ITN processing of a number using a structured table and rewriting rules in accordance with an embodiment. As mentioned above, in the example of the spoken number <two hundred twenty three thousand five hundred eighty two>, processing starts from the rightmost word <two> by scanning one word at each time, from right to left using an ITN lexicon. <2> is placed into the ones column, followed by <8,0> being placed into the tens column, followed by <5> being placed into the hundreds column, and so on. Cells may be initialized as <NULL>, and position cells may be assigned as <Y> when the corresponding position is found from the ITN lexicon when parsing the text stream. The position value is regarded as an anchor for parsing. For the example of <six hundred and one>, the rightmost number <one> is parsed in D(1), and the pointer is moved into P(3,2) when position <hundred> is found. The next number <six> is placed in D(3) next to P(3,2), accordingly. Then, the post processing rules discussed above may be applied to resolve any double digit numbers, such as <8,0> in the tens digit and the <2,0> in the tens of thousands digit.

The context-free grammar and/or rules set forth below may be used to parse an ITN phrase. If the given phrase matches a rule listed below, then the phrase may classified into the corresponding class. For more details about rule matching, please refer to “Speech and Language Processing: An Introduction to Natural Language Processing, Computational Linguistics, and Speech Recognition” by D. Jurafsky and J. Martin (Prentice Hall, 2000).

DATE (R_Date):

[DATE] may be identified by matching a [DATE] ITN lexicon entry.

If any $W, that ($Wε$P)∩($Wε[DATE])=TRUE, and in the following date pattern: [$Wnumber] $Wdate [$Wnumber] [$Wnumber], the matched word is denoted as $Wdate, then $Pε[DATE]

R_Date:

[$Wnumber] $Wdate [$Wnumber] [$Wnumber]->[R_Number($Wnumber)] ITN_Lexicon($Wdate) [R_Number($Wnumber),] [R_Number($Wnumber)]

TIME (R_Time):

[TIME] may be identified by matching a [TIME] ITN lexicon entry. The matched word is denoted as $Wtime, if any $W, that ($Wε$P)∩($Wε[TIME])=TRUE, and in the following time pattern: [<at>] $Wnumber $Wtime or $Wnumber1 <to > $Wnumber2 or $Wnumber1 <past> $Wnumber2, then $Pε[TIME]

R_Time:

[<at>] $Wnumber $Wtime->[<at >] R_Number($Wnumber) $Wtime and Separator=<:>

$Wnumber1 <past> $Wnumber2->R_Number($Wnumber2) <:> R_Number($Wnumber1)

$Wnumber1 <to> $Wnumber2->R_Number($Wnumber2)-1 <:> 60-R_Number($Wnumber1)

Currency (R_Currency):

[CURRENCY] may be identified by matching a [CURRENCY] ITN lexicon entry.

If any $W, that ($Wε$P)∩($Wε[CURRENCY])=TRUE, and in the following currency pattern: $Wnumber $Wcurrency, the matched word is denoted as $Wcurrency, then $Pε[CURRENCY].

R_Currency:

$Wnumber $Wcurrency->R_Number($Wnumber) ITN_lexicon($Wcurrency)

Exceptional handling may be performed by reordering, triggered by reordering marker in ITN lexicon: $Wnumber $Wcurrency->ITN_lexicon($Wcurrency) R_Number($Wnumber).

Metrics (R_Metric):

[METRIC] may be identified by matching a [METRIC] ITN lexicon entry.

If any $W, that ($Wε$P)∩($Wε[METRIC])=TRUE, and in the following metric pattern: Wnumber $Wmetric, the matched word is denoted as $Wmetric, then $Pε[METRIC].

R_Metric:

$Wnumber $Wmetric->R_Number($Wnumber) ITN_lexicon($Wmetric).

Address (R_Add), Phone (R_phone), Zip/Postal code (R_Code)

Addresses, phone numbers, and postal codes may be handled as general numbers [NUMBER].

One or more aspects of the invention may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), application specific integrated circuits (ASIC), and the like.

For example, in certain embodiments, functions, including, but not limited to, the following functions, may be performed by a processor executing computer-executable instructions that are recorded on a computer-readable medium: segmenting text in spoken form into inverse text normalization items by grouping consecutive words using an inverse text normalization lexicon; classifying the inverse text normalization items into inverse text normalization categories by using the inverse text normalization lexicon; applying one or more inverse text normalization rules that are selected based on the inverse text normalization categories into which inverse text normalization items have been classified to rewrite the inverse text normalization items; post processing the inverse text normalization item and outputting inversely normalized text in written form for display; and preprocessing the text in spoken form to make the text in spoken form language independent.

Embodiments include any novel feature or combination of features disclosed herein either explicitly or any generalization thereof. While embodiments have been described with respect to specific examples including presently preferred modes of carrying out the invention, those skilled in the art will appreciate that there are numerous variations and permutations of the above described systems and techniques. Thus, the spirit and scope of the invention should be construed broadly as set forth in the appended claims.

We claim:

1. A method comprising:
segmenting text in spoken form into inverse text normalization items by grouping consecutive words using an inverse text normalization lexicon;
classifying the inverse text normalization items into inverse text normalization categories by using the inverse text normalization lexicon;
applying one or more inverse text normalization rules that are selected based on the inverse text normalization categories into which inverse text normalization items have been classified to rewrite the inverse text normalization items; and
post processing the inverse text normalization item and outputting inversely normalized text in written form for display.

2. The method of claim 1, wherein the inverse text normalization lexicon includes inverse text normalization lexicon entries that are each located within an inverse text normalization lexicon category in the inverse text normalization lexicon.

3. The method of claim 2, wherein the inverse text normalization lexicon entries each include a spoken word and a corresponding normalized written form of the spoken word.

4. The method of claim 2, wherein the inverse text normalization lexicon categories include a number category.

5. The method of claim 4, wherein addresses, phone numbers, and postal codes are classified into the number category.

6. The method of claim 4, wherein the inverse text normalization lexicon number category includes inverse text normalization single digit lexicon entries and double digit lexicon entries.

7. The method of claim 6, wherein applying the one or more inverse text normalization rules to inverse text normalization items in the number category is performed in reverse order relative to the order in which the numbers appear in the text in spoken form.

8. The method of claim 6, wherein post processing includes resolving conflicts between single digit and double digit lexicon entries in adjacent place values in the inversely normalized text.

9. The method of claim 1, further comprising: preprocessing the text in spoken form to make the text in spoken form language independent.

10. Apparatus comprising a processor and a memory containing executable instructions that, when executed by the processor, perform:
segmenting text in spoken form into inverse text normalization items by grouping consecutive words using an inverse text normalization lexicon;
classifying the inverse text normalization items into inverse text normalization categories by using the inverse text normalization lexicon;
applying one or more inverse text normalization rules that are selected based on the inverse text normalization categories into which inverse text normalization items have been classified to rewrite the inverse text normalization items; and
post processing the inverse text normalization item and outputting inversely normalized text in written form for display.

11. The apparatus of claim 10, wherein the inverse text normalization lexicon includes inverse text normalization lexicon entries that are each located within an inverse text normalization lexicon category in the inverse text normalization lexicon.

12. The apparatus of claim 11, wherein the inverse text normalization lexicon entries each include a spoken word and a corresponding normalized written form of the spoken word.

13. The apparatus of claim 11, wherein the inverse text normalization lexicon categories include a number category.

14. The apparatus of claim 13, wherein addresses, phone numbers, and postal codes are classified into the number category.

15. The apparatus of claim 13, wherein the inverse text normalization lexicon number category includes inverse text normalization single digit lexicon entries and double digit lexicon entries.

16. The apparatus of claim 15, wherein applying the one or more inverse text normalization rules to inverse text normalization items in the number category is performed in reverse order relative to the order in which the numbers appear in the text in spoken form.

17. The apparatus of claim 15, wherein post processing includes resolving conflicts between single digit and double digit lexicon entries in adjacent place values in the inversely normalized text.

18. The apparatus of claim 10, wherein the text in spoken form is preprocessed to make the text in spoken form language independent.

19. A computer-readable medium having recorded thereon computer-executable instructions, that, when executed, perform operations comprising:
segmenting text in spoken form into inverse text normalization items by grouping consecutive words using an inverse text normalization lexicon;
classifying the inverse text normalization items into inverse text normalization categories by using the inverse text normalization lexicon;
applying one or more inverse text normalization rules that are selected based on the inverse text normalization categories into which inverse text normalization items have been classified to rewrite the inverse text normalization items; and
post processing the inverse text normalization item and displaying on an display screen inversely normalized text in written form for display.

20. The computer-readable medium of claim 19, wherein the inverse text normalization lexicon includes inverse text normalization lexicon entries that are each located within an inverse text normalization lexicon category in the inverse text normalization lexicon.

21. The computer-readable medium of claim 20, wherein the inverse text normalization lexicon categories include a number category.

22. The computer-readable medium of claim 21, wherein the inverse text normalization lexicon number category includes inverse text normalization single digit lexicon entries and double digit lexicon entries.

23. The computer-readable medium of claim 22, wherein applying the one or more inverse text normalization rules to inverse text normalization items in the number category is performed in reverse order relative to the order in which the numbers appear in the text in spoken form.

24. Apparatus comprising:
means for segmenting text in spoken form into inverse text normalization items by grouping consecutive words using an inverse text normalization lexicon;
means for classifying the inverse text normalization items into inverse text normalization categories by using the inverse text normalization lexicon;
means for applying one or more inverse text normalization rules that are selected based on the inverse text normalization categories into which inverse text normalization items have been classified to rewrite the inverse text normalization items; and
means for post processing the inverse text normalization item and outputting inversely normalized text in written form for display.

25. The apparatus of claim 24, further comprising: means for preprocessing the text in spoken form to make the text in spoken form language independent.
